(19) United States
(12) Patent Application Publication
(10) Pub. No.: US 2006/0140265 A1
(43) Pub. Date: Jun. 29, 2006

(54) System circuit and method for transmitting media related data

(75) Inventors: Eran Igler, Tel Aviv (IL); Avner Taieb, Petach Tikva (IL); Florin Calin, Hod-hasharon (IL)

Correspondence Address: Eitan Law Group;C/O LandonIP, Inc., Suite 450, 1700 Diagonal Road, Alexandria, VA, 22314, US

(73) Assignee: Adimos Inc.

(21) Appl. No.: 11/023,422

(22) Filed: Dec. 29, 2004

(51) Int. Cl. H04N 11/04; H04N 11/02; H04N 7/12; H04B 1/66

(52) U.S. Cl. 375/240.01

(57) ABSTRACT

There is provided, in accordance with some embodiments of the present invention a system, method and circuit for compensating for delays introduced by varying processing loads associated with the transmission of related media component signals to dispersed and separate media presentation devices. According to some embodiments of the present invention, a signal containing multimedia content, analog or digital, may be separated into two or more component signals, analog or digital, where each of the component signals may contain data associated with one or more of the media components of the multimedia signal. A delay circuit or buffer may introduce a delay to one of the component signals in order to compensate for processing related delays associated with the other component signal.

### FIELD OF THE INVENTION

The present invention generally relates to the field of communication. More specifically, the present invention relates to a system circuit and method for transmitting media related data.

### BACKGROUND

Since the development of crude communication systems based on electrical signals, the world's appetite for more and more advanced forms of communication has continually increased. From wired cable networks over which operators would exchange messages using Morse-Code, to the broadband wireless networks of today, whenever technology has provided a means by which to communicate more information, people have found a use for that means, and have demanded more.

In the ever-evolving field of communications, new forms of media (e.g. sound, images, video, interactive multi-media content, etc.) are constantly being developed and improved. Most homes, business and various other locations in the developed world today have devices capable of receiving and displaying or playing content in various format and media types. More specifically, today's modern home, office, or home-office may contain at least one television, and mostly likely will also include a computer, a stereo, a DVD player, and a proprietary content provider's (e.g. cable or wireless content provider) decoder box. The terms “Home Theater”, “Home Entertainment Center” or “Media Center” have been coined to designate a set of devices or even complex media presentation systems for the presentation of content to persons within a home or office. With the continual evolution of the various media types in which content is being delivered, the devices and systems used receive and present that content is also evolving and growing in number.

As the number and complexity of devices and systems used is growing, so is the need to interconnect these devices. Since many devices need to be connected with other devices in order to function fully and properly (e.g. a DVD player needs to be connected to a Video Display and to an Audio Output System), the need for means to establish efficient connections or networks of connections between various home devices and systems is growing. Since modern communication devices and networks today are best characterized by features such as high bandwidth/data-rate, complex communication protocols, various transmission medium, and various access means, solutions for interconnecting media related devices and systems to date have typically centered around wiring the devices to one another using various cables of various configurations and sizes. For example, fiber optic cables, which are used as part of data networks spanning much of the world's surface, are sometimes used to connect the audio output of CD or DVD to an Audio System.

More recently, wireless (i.e. Radio Frequency) transceivers, protocols and networks (Bluetooth, WiFi, WiFi-Max, etc.) have been used to interconnect various devices in the home and office. Although wireless interconnection of devices is typically easier and cleaner to implement than using wiring which needs to be installed and placed so as not to be intrusive and/or unaesthetic, with the use of wireless transceivers for interconnection of device, variable delays associated with the compression, transmission and decompression of media related data has become an issue. More specifically, since by definition, and given multimedia content or presentation (e.g. a movie or an interactive movie) has several media components, such as video and audio, and since each media component may require a different level and method of compression, each of the related media components may require a different level of processing in order to be transmitted to and presented at the respective devices where it is presented (e.g. video data transmitted to a video display, and audio data transmitted to an audio receiver and speaker system).

For example, if a multimedia presentation, such as a movie played from a Digital Video Recorder or from a set-top cable receiver, is to be transmitted to a video display of projector and to an audio systems, the video component of the movie may be compressed by a first video compression method (e.g. MPEG 2) and transmitted to a receiver connected to the video display and the audio component of the movie may be compressed by a second audio specific compression method (e.g. MPEG 1—layer ii or MPEG 4—aac) and transmitted to a receiver connected with audio system. Since video compression and decompression is far more processing intensive than is audio compression and decompression, the delays associated with presenting the video content may be greater than those associated with the audio content and a loss of synchronization may occur.

There is a need for systems, methods and circuits for compensating for delays introduced by varying processing loads associated with the transmission of related media components to dispersed and separate media presentation devices.

### SUMMARY OF THE INVENTION

There is provided, in accordance with some embodiments of the present invention, a system, method and circuit for compensating for delays introduced by varying processing loads associated with the transmission of related media components to dispersed and separate media presentation devices. According to some embodiments of the present invention, a signal containing multimedia content, analog or digital, may be separated into two or more component signals, analog or digital, where each of component signals may contain data associated with one or more of the media components of the multimedia signal. Prior to the transmission of a first component signal to a first presentation device, or to a receiver connected with the first presentation device, data associated with the content contained in the first component signal may be compressed, and upon receipt of the transmitted signal at the first device, the compressed data may be decompressed and presented. A first delay value associated with the compression, transmission, decompression and/or presentation of the content in the first component signal may be estimated, either in advance of the transmission or dynamically during transmission. According to further embodiments of the present invention, a second component signal may be transmitted to a second device, and prior to transmission of the second signal to the second device a delay may be introduced to the second component signal, wherein the magnitude of the delay introduced to the second component signal may be derived from the first delay value. According to further embodiments of the present invention, the delay may be introduced at the second device or at a receiver connected to the second device.

According to some embodiments of the present invention, a second delay value associated with the compression, transmission, decompression and/or presentation of the content in the second component signal may be estimated. The magnitude of the delay introduce to the second component signal, either prior to transmission or at the second device, may be estimated such that the introduced delay combined with the second delay value associated with the second device are substantially equal to the first delay value.

According to further embodiments of the present invention, a given receiver connected to a given presentation device may provide a feedback signal indicating a delay value associated with the given components signal received by the given received and presented by the given presentation device. The magnitude of a delay introduced to any other component signal may be derived from the feedback signal.

According to some embodiments of the present invention, each of three or more component signals may be transmitted to three or more presentation devices, and a separate delay may be introduced to two or more of the component signals.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing an exemplary arrangement of media related devices, according to some embodiments of the present invention, wherein an audio component signal is transmitted to a receiver connected to an audio system and a video component signal is transmitted to a receiver connected to a video display or projector;

FIG. 2 is a block diagram showing an exemplary arrangement of media related devices, according to some embodiments of the present invention, wherein an audio component signal is transmitted to an audio system through a wire or cable, and a video component signal is transmitted to a wireless receiver connected to a video display or projector;

FIG. 3 is a set of three block diagrams illustrating an audio/video transmitter and a set of receivers according to some embodiments of the present invention, wherein a composite audio/video signal received by the transmitter is parsed into a video component signal which is transmitted to a video receiver and into an audio component signal which is transmitted to an audio receiver;

FIG. 4 is a set of three block diagrams illustrating an audio/video transmitter and a set of receivers according to some embodiments of the present invention, wherein a related audio and video signals are received by the transmitter and the video component signal is transmitted to a video receiver and the audio component signal is transmitted to an audio receiver; and

FIG. 5 is a flowchart illustration of the steps of an exemplary method, according to some embodiments of the present invention, by which related audio and video signals may be transmitted to media presentation devices such as a video monitor or projector and an audio system.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

There is provided, in accordance with some embodiments of the present invention a system, method and circuit for compensating for delays introduced by varying processing loads associated with the transmission of related media components to dispersed and separate media presentation devices. According to some embodiments of the present invention, a signal containing multimedia content, analog or digital, may be separated into two or more component signals, analog or digital, where each of component signals may contain data associated with one or more of the media components of the multimedia signal. Prior to the transmission of a first component signal to a first presentation device, or to a receiver connected with the first presentation device, data associated with the content contained in the first component signal may be compressed, and upon receipt of the transmitted signal at the first device, the compressed data may be decompressed and presented. A first delay value associated with the compression, transmission, decompression and/or presentation of the content in the first component signal may be estimated, either in advance of the transmission or dynamically during transmission. According to further embodiments of the present invention, a second component signal may be transmitted to a second device, and prior to transmission of the second signal to the second device a delay may be introduced to the second component signal, wherein the magnitude of the delay introduced to the second component signal may be derived from the first delay value. According to further embodiments of the present invention, the delay may be introduced at the second device or at a receiver connected to the second device.

According to some embodiments of the present invention, a second delay value associated with the compression, transmission, decompression and/or presentation of the content in the second component signal may be estimated. The magnitude of the delay introduce to the second component signal, either prior to transmission or at the second device, may be estimated such that the introduced delay combined with the second delay value associated with the second device are substantially equal to the first delay value.

According to further embodiments of the present invention, a given receiver connected to a given presentation device may provide a feedback signal indicating a delay value associated with the given components signal received by the given received and presented by the given presentation device. The magnitude of a delay introduced to any other component signal may be derived from the feedback signal.

According to some embodiments of the present invention, each of three or more component signals may be transmitted to three or more presentation devices, and a separate delay may be introduced to two or more of the component signals.

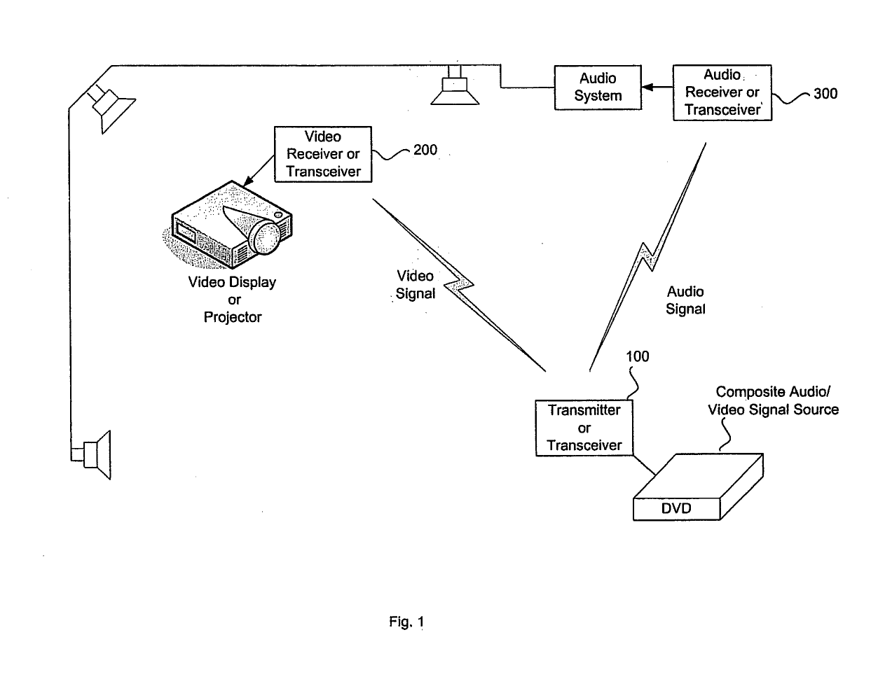

Turning now to FIG. 1, there is shown a block diagram of an exemplary arrangement of media related devices, according to some embodiments of the present invention, wherein an audio component signal may be transmitted to a receiver connected to an audio system and a video component signal is transmitted to a receiver connected to a video display or projector. The content signal source in FIG. 1 is a Digital Video Device (“DVD”) which may read content from an optical storage medium, where the data is stored according to some multimedia standard (e.g. MPEG 2, MPEG 4, VCD, etc.), and may generate either two synchronized but separate audio and video signals or may provide a composite signal with both the video and audio information interlaced.

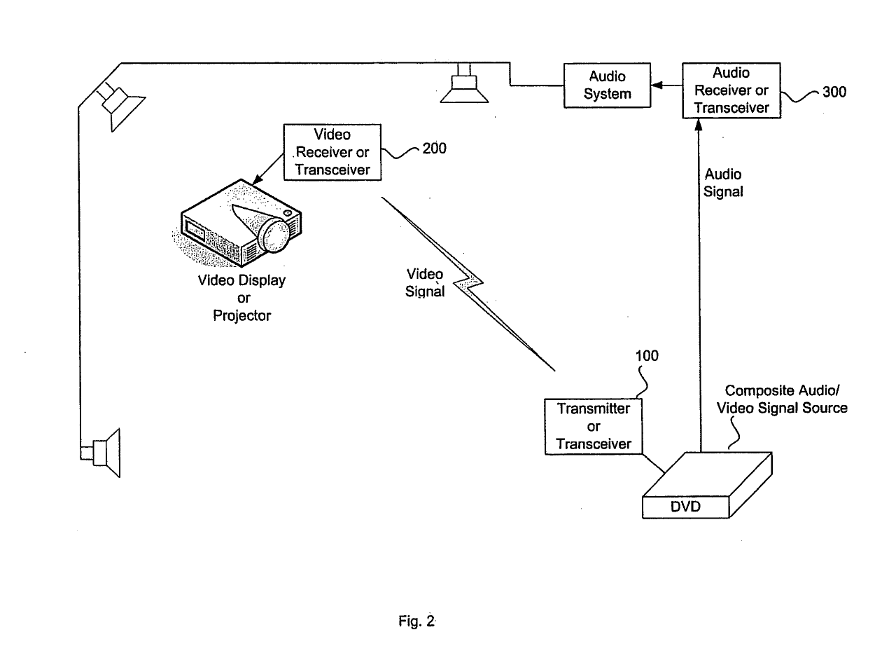

Transmitter 100 may receive from the signal source (e.g. DVD) either the composite signal or the component signals to be presented, and may transmit the relevant information to the relevant presentation devices (i.e. video signal to video display and audio signal to audio system) either over a wire or cable, or wirelessly, according to any of the known wireless technologies and standards (e.g. Radio Frequency, Infrared, WiFi, Bluetooth, etc.) known today or to be devised in the future. Receivers corresponding to transmitter 100 may either be incorporated into their respective media presentation devices, or may be connected to their respective media presentation devices through external interface ports or connections points on the devices. That is, video receiver or transceiver 200 may be either incorporated in or connected to a video display or projector, and audio receiver or transceiver 300 may be connected to an audio system. According to an embodiment of the present invention shown in FIG. 2, an exemplary arrangement of media related devices may involve an audio component signal being transmitted to an audio system through a wire or cable, and only the video component signal may be transmitted to a wireless receiver connected to a video display or projector. It should be clear to one or ordinary skill in the art that various aspect of the present invention are applicable to almost any permutation of arrangements of media storage/playing devices and media presentation devices, wherein at least one wireless data link is used.

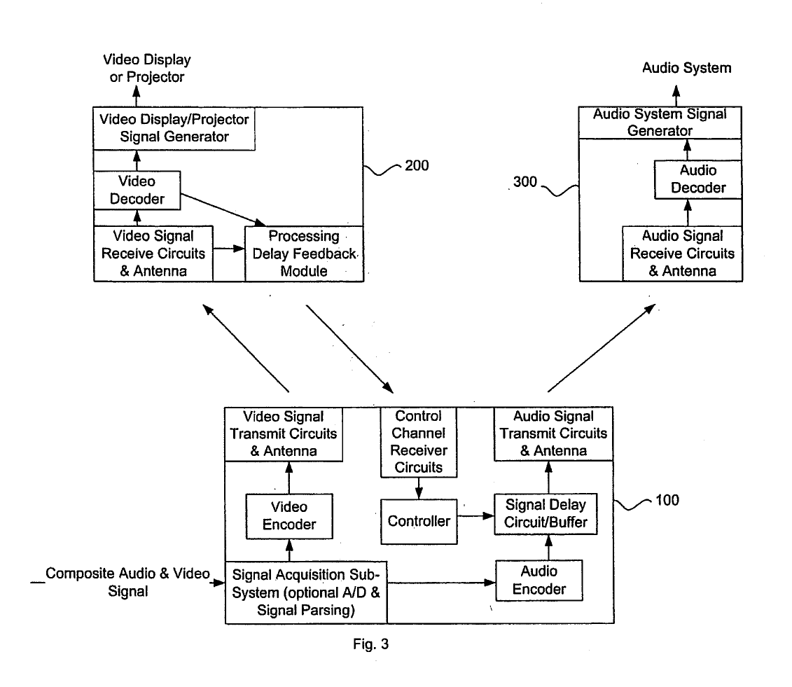

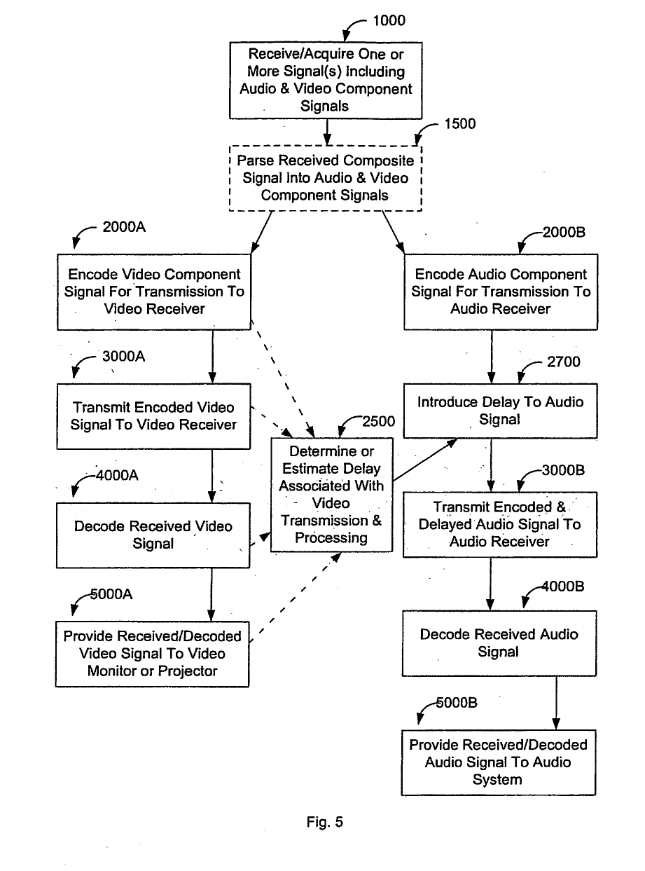

Turning now to FIG. 3, there is shown a set of three block diagrams illustrating an audio/video transmitter 100 and a set of receivers, 200 and 300, according to some embodiments of the present invention, wherein a composite audio/video signal received by the transmitter is sampled and parsed into a video component signal which is transmitted to a video receiver 200 and into an audio component signal which is transmitted to an audio receiver 300. The operation of the transmitter 100 and receivers, 200 & 300, may be described with reference to FIG. 5, which is a flowchart illustration of the steps of an exemplary method, according to some embodiments of the present invention, by which related audio and video signals may be transmitted to media presentation devices such as a video monitor or projector and an audio system. A composite signal, containing both audio and video associated with the same presentation (e.g. a movie played on a DVD) may be received (step 1000) at a signal acquisition subsystem of the transmitter 100, wherein the acquisition subsystem may include an analog to digital converter or some other signal sampling or acquisition circuits, such that the composite signal may be converted to a native signal format of the transmitter and/or may be parsed/separated (step 1500) into a video component signals and into an audio component signal.

The video component signal may be encoded and/or compressed (step 2000A) by a video encoder using any video compression method known today or to be devised in the future, and the encoded video signal may be transmitted (step 3000A) to a video receiver 200 using any wireless transmission technology or standard. According to some embodiments of the present invention, the video component signal may be compressed/encoded using MPEG 2 compression and may be transmitted over a WiFi or other wireless data network link technology.

The audio component signal may be encoded and/or compressed (step 2000B) by an audio encoder using any audio compression method known today or to be devised in the future, and the encoded audio signal may be transmitted (step 3000B) to an audio receiver 300 using any wireless transmission technology or standard. According to some embodiments of the present invention, the audio may be compressed/encoded using MPEG 2—layer ii compression and me be transmitted over a WiFi or other wireless data network link technology.

A controller on the transmitter 100 may determine or estimate a processing related delay associated with the encoding, transmitting and decoding of the video component signal (step 2500). The controller may either determine or estimate the processing related delay value based on preprogrammed values provided to the controller during production of the transmitter and receivers, or the controller may dynamically determine the processing related delay value based on a feedback signal from a processing delay feedback module on the video receiver 200. The feedback signal may be received by the controller over a control channel receiver circuit. According to further embodiments of the present invention, the controller may also determine or estimate a processing related delay value associated with the encoding transmission and decoded of the audio signal. The controller may either determine or estimate the processing related delay value based on preprogrammed values provided to the controller during production of the transmitter and receivers, or the controller may dynamically determine the processing related delay value based on a feedback signal from a processing delay feedback module on the audio receiver 300.

It should be clear to one of ordinary skill in the art that according to embodiments of the present invention where processing related delays are relatively fixed and previously known or estimated, there may not be a need for a controller, and the introduced delay may be fixed and/or pre-calculated. Thus, step 2500 may either be implemented dynamically and substantially in real-time during operation, when the delays are variable, or step 2500 may be omitted and/or replaced by a step of pre-measuring or pre-estimating substantially fixed processing related delay values associated with each of the component signals.

According to some embodiments of the present invention, the processing related delay associated with a given content component signal may composed of delays introduced by content compression, wireless transmission and reception, and decompression of the content. According to some embodiments of the present invention, the delay associated with wireless transmission and reception of content may be significantly greater than other the delay associated with content compression and decompression.

Based on the processing related delay value or values associated with the video component signal, and possibly associated with the audio component signal, the controller may determine an induced delay value. The induced delay value may be provided to a delay circuit or buffer associated with the audio component signal such that a delay is introduced to the audio component signal (step 2700). It should be understood by one of ordinary skill in the art that although the delay circuit/buffer is shown on the transmitter 100, the delay circuit/buffer may also be implemented on the audio receiver 300.

Various methodologies, all of which are applicable to present invention, may be used to determine an induced delay value. A common characteristic of these methodologies is that the induced delay value is intended to compensate for the component signal having the greater processing associated delay. For example, if the encoding, transmission and decoding of the video component signal is roughly 100 milliseconds, while the corresponding encoding, transmission and decoding of the audio component signal only roughly 20 milliseconds, the induced delay value may be determined to be roughly 80 milliseconds. By introducing an induced delay (step 2700) into the signal chain having the smaller latency, signal synchronization at the point of presentation may be maintained. It should be clear to one of ordinary skill in the art that various aspects of the present invention may be applied to more than just two media component signals, and may be extended to countless related signal chains, where synchronization at the point/time of presentation intended.

At each of the receivers, video 200 and audio 300, received signals may be decoded/decompressed (steps 4000A & 4000B) and the decoded/decompressed signal may be formatted or conditioned (steps 5000A & 5000B) so as to be compatible to the their respective presentation devices. The video decoder of video receiver 200 may include an MPEG decoder and may also include some video encoding circuitry or logic adapted to provide a video signal suitable for a video display device or projector.

As illustrated in FIG. 2, according to some embodiments of the present invention, the audio component signal may be transmitted to an audio system via cable or wire, and may thus not require encoding, wireless transmission and decoding. According to such embodiments of the present invention, the processing related delay values associated with the audio component signal may be considered negligible, and the calculation of an induced delay value may only take into consideration the processing related delay of the video component signal.

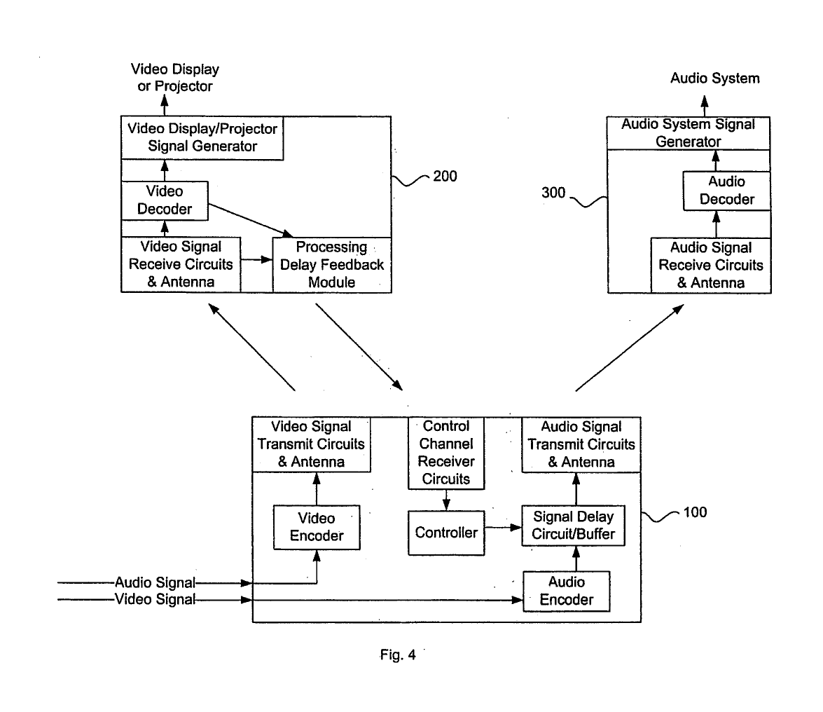

Turning now to FIG. 4, there is shown a set of three block diagrams illustrating an audio/video transmitter 100 and a set of receivers, 200 and 300, according to some embodiments of the present invention, wherein related and synchronized audio and video signals are received by the transmitter 100 and the video component signal is transmitted to a video receiver 200 and the audio component signal is transmitted to an audio receiver 200. The description of the elements within FIG. 4, and their operation, is essentially the same as that for FIG. 3, with the exception that signal sampling and parsing may not be required according to the embodiment of FIG. 4. Since the transmitter 100 according to FIG. 4 is receiving two separate and synchronized signals, a video signal and an audio signal, there may be no need for signal parsing or separation, or any of the circuitry associated with such functions (e.g. A/D etc . . . ).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method of transmitting related component signals to two or more media presentation devices comprising:
a. parsing a signal containing multimedia content into two or more component signals where each of the two or more component signals contains a media component of the multimedia content;
b. transmitting each of the two or more component signals to a separate media presentation device, wherein there is a processing related delay value associated with the transmission of each of the two or more signals to their respective presentation devices;
c. Introducing a delay to the component signal having the smaller processing related value, such that the introduced delay combined with the smaller processing related value is substantially equal to the processing delay value of the signal having the greater processing related delay value.

2. The method according to claim 1, wherein the processing related delay value associated with each component signal is predefined.

3. The method according to claim 1, further comprising determining a processing related delay value for one or more component signals.

4. The method according to claim 1, wherein one of the component signals contains video content and the processing related delay is primarily associated with the compression and/or decompression of the video content.

5. The method according to claim 4, wherein one of the component signals contains audio content and the processing related delay is primarily associated with the compression and/or decompression of the audio content.

6. The method according to claim 5, wherein the processing related delay associated with the video component signal is greater than the processing related delay associated with the audio component signal.

7. The method according to claim 6, wherein a delay is introduced to the audio component signal such that the introduced delay combined with the processing related delay associated with the audio component signal is substantially equal to the processing related delay of the video component signal.

8. The method according to claim 1, wherein the introduced delay is fixed based on predefined processing related values.

9. The method according to claim 8, further comprising dynamically determining processing related delay values for one or more of component signals and determining a magnitude of an introduced delay based on the one or more dynamically determined processing related delays.

10. A circuit for compensating for processing related delays associated with the transmission of two or more related component signals to two or more media presentation devices, wherein one component signal has a relatively greater processing related delay value than other component signals, said circuit comprising:
a signal delay circuit or buffer adapted to introduce a delay to a component signal having a relatively smaller processing related delay value, such that the introduced delay combined with the smaller processing related delay value is substantially equal to a processing related delay value of the component signal having a relatively greater processing related delay value;

11. The circuit according to claim 10, further comprising a controller functionally associated with said delay circuit or buffer, wherein said controlled is adapted to instruct said delay circuit as to the magnitude of the delay to introduce.

12. The circuit according to claim 10, further comprising a controller functionally associated with said delay circuit or buffer, wherein said controlled is adapted to determine a processing related delay value for one or more component signals.

13. The circuit according to claim 10, wherein one of the component signals contains video content and the processing related delay is primarily associated with the compression and/or decompression of the video content, one of the component signals contains audio data and the processing related delay is primarily associated with the compression and/or decompression of the audio content, and the processing related delay associated with the video component signal is greater than the processing related delay associated with the audio component signal.

14. The circuit according to claim 15, wherein said controller instructs the delay circuit or buffer to introduce a delay to the audio component signal such that the introduced delay combined with the processing related delay associated with the audio component signal is substantially equal to the processing related delay of the video component signal.

15. A system for compensating for processing related delays associated with the transmission of two or more related component signals to two or more media presentation devices, wherein one component signal has a relatively greater processing related delay value than other component signals, said circuit comprising:
a signal delay circuit or buffer coupled to a transmitter or to a receiver, said delay circuit or buffer adapted to introduce a delay to a component signal having a relatively smaller processing related delay value, such that the introduced delay combined with the smaller processing related delay value is substantially equal to a processing related delay value of the component signal having a relatively greater processing related delay value;

16. The circuit according to claim 17, further comprising a controller functionally associated with said delay circuit or buffer, wherein said controlled is adapted to instruct said delay circuit as to the magnitude of the delay to introduce.

17. The circuit according to claim 17, further comprising a controller functionally associated with said delay circuit or buffer, wherein said controlled is adapted to determine a processing related delay value for one or more component signals.

18. The circuit according to claim 17, wherein one of the component signals contains video content and the processing related delay is primarily associated with the compression and/or decompression of the video content.

19. The circuit according to claim 20, wherein one of the component signals contains audio data and the processing related delay is primarily associated with the compression and/or decompression of the audio content.

20. The circuit according to claim 21, wherein the processing related delay associated with the video component signal is greater than the processing related delay associated with the audio component signal.

21. The circuit according to claim 22, wherein said controller instructs the delay circuit or buffer to introduced a delay to the audio component signal such that the introduced delay combined with the processing related delay associated with the audio component signal is substantially equal to the processing related delay of the video component signal.
